(19) United States
(12) Patent Application Publication
(10) Pub. No.: US 2016/0323523 A1
(43) Pub. Date: Nov. 3, 2016

(54) Multiple Image Sensing Pixel Arrays with Sharing Common Control Circuits

(71) Applicant: Mass International Co., Ltd., Apia (WS)

(72) Inventor: Kuo-Ching CHIANG, New Taipei City (TW)

(21) Appl. No.: 14/701,505

(22) Filed: Apr. 30, 2015

(51) Int. Cl. H04N 5/341

(52) U.S. Cl. CPC H04N 5/341

(57) ABSTRACT

The present invention discloses an image sensing module having a sharing circuits formed on a substrate; a first image pixel array is coupled with the sharing circuits, a second image pixel array is coupled with the sharing circuits; and a switch is coupled with the sharing circuits to switch the sharing circuit to process signal for the first image pixel array or the second image pixel array.

### BACKGROUND OF RELATED ART

1. Technical Field

The present invention relates to an image sensor, and particularly to multiple CMOS image sensor chips with at least one sharing common control circuits. More particularly, the control circuits contain at least one logic image signal processor.

2. Background Art

CMOS (Complementary Metal Oxide Semiconductor) image sensor has been widely employed into a portable phone, a compact digital camera and the like. There are many types of pixel sensors including the CMOS image sensor used most commonly in cell phone cameras. In CMOS image sensors, electric charge stored in a photoelectric conversion section is transferred to a charge-voltage converter, and a voltage obtained in the charge-voltage converter is output. An electronic shutter function is realized by periodically resetting the charge-voltage converter. The exposure is set for all the pixels arranged in a two-dimensional array on a pixel by-pixel row basis. High performance image sensor has also been developed. The A/D converter and the analog signals in selected columns are collectively output to respective vertical signal lines. Photodiodes may be used for a CMOS image sensor. The photodiode is configured to convert light into electric signal. CMOS image sensors may be classified into front-side illumination (FSI) CMOS image sensors and back-side illumination (BSI) image sensors. In FSI CMOS image sensors, light may be incident to a front surface of a substrate on which an interconnection layer is disposed. In BSI CMOS image sensors, light may be incident to a rear surface disposed opposite the front surface of the substrate on which an interconnection layer is disposed.

Currently a CMOS image sensor chip (CIS chip) contains a pixel array 700 and a control circuits. The control circuits generally include logic image signal processor (ISP) 710, memory (such as non-volatile memory, SRAM, DRAM) 720, analog circuits 730 and input/output circuits 740, as shown in FIG. 6. Function of the control circuits is processing signal from pixel array, improve image quality or storing photo images.

In the CIS chip, the layout area of the control circuits is large and occupies too much chip area, as shown in FIG. 7. When a smart phone is equipped with multiple cameras (such as front camera and rear camera), it requires multiple CIS chips, i.e., a front camera requires the first CIS chip and a rear camera requires the second CIS chip. Each one of the two CIS chips has its own control circuits, respectively.

However, because control circuits occupy large portion of a chip area, the first CIS chip has a control circuit, and the second CIS chip has another control circuit, the configuration is disadvantageous to form factor of a smart phone.

### SUMMARY

The present invention includes a common control circuits; a first pixel array coupled with the common control circuits; a second pixel array coupled with the common control circuits; and a switch coupled with the common control circuits to switch the common control circuit to process signal for the first image sensor or the second image sensor. The common control circuits include logic image processor, analog circuits, analog to digital conversion circuits, memory and/or input/output circuits.

The common control circuits and the first pixel array are formed in the first chip, a second pixel array are formed in a second chip. The second pixel array shares the common control circuits with the first pixel array. In this embodiment, size of the second chip is greatly reduced because of no control circuits formed thereon.

For rear camera of a portable device, the second pixel array is BSI pixel formed in the second chip (back-side of a silicon substrate) which does not contain the control circuits. For front camera, the first chip contains the first pixel array (formed in back-side of a silicon substrate) and the common control circuits (formed in front-side of a silicon substrate), wherein the common control circuits are shared by the second pixel array. Generally, the semiconductor process for making control circuits is not compatible with pixel array. Therefore, in addition to reduction of form factor, because of process simplicity, the second pixel array provides better image quality and is used for rear camera.

Alternatively, for rear camera of a portable device, the second pixel array is BSI pixel formed in the second chip (back-side of a silicon substrate) containing the control circuits (formed in front-side of the second chip). For front camera, the first chip contains the first pixel array (formed in front-side or back-side of a silicon substrate) and does not contain the common control circuits, the common control circuits formed in the second chip is shared by the first pixel array.

In another embodiment: For rear camera of a portable device, a stacked-chip includes a pixel array formed in the first chip and common control circuits formed in the second chip. For front camera, a third chip contains a pixel array while not containing the common control circuits, wherein the common control circuits are shared by the third pixel array. The stacking of the first chip and the second chip further reduces form factor of the portable device.

The present invention disclosed an image sensing module including a circuit; a first image pixel array coupled with the sharing circuits; a second image pixel array coupled with the circuits; and a switch coupled with the circuits to switch the circuit to process signal for the first image pixel array or the second pixel array. The circuits includes analog processing circuits, analog to digital conversion circuits, memory, timing and control circuits. The circuits and the first image pixel array are formed within a first chip, the second image pixel array is formed within a second chip. Alternatively, the circuits is adjacent with the first image pixel array or the first image pixel array is over the circuits.

Alternatively, the first image pixel array is formed within a first chip, the second image pixel array being formed within a second chip, the sharing circuits being formed within a third chip. The first chip is over the second chip or the second chip is over the first chip. Alternatively, the first image pixel array is formed within a first chip, the circuits and the second image pixel array are formed within a second chip. The circuit is adjacent with the second image pixel array; or the second image pixel array is over the circuits.

An image sensing module includes a circuits formed on a substrate; a first image pixel array coupled with the circuits; a second image pixel array coupled with the circuits; and a switch coupled with the circuits to switch the circuit to process signal for the first image pixel array or the second image pixel array, wherein the substrate is flexible, the circuits, the first image pixel array and the second image pixel array being formed at the same side; the substrate being bent to allow the circuits and the first image pixel array opposite to the second image pixel array. The first image pixel array is formed adjacent or over the circuits.

### BRIEF DESCRIPTION OF THE DRAWINGS

FIG. 1 is a circuit diagram showing a configuration of an example of a CMOS sensor;

FIG. 2 is a cross-sectional illustration which shows an example of the present invention;

FIG. 2A is a cross-sectional illustration which shows an example of the present invention;

FIG. 2B is a cross-sectional illustration which shows an example of the present invention;

FIG. 3 is a cross-sectional illustration which shows an example of the present invention;

FIG. 3A is a cross-sectional illustration which shows an example of the present invention;

FIG. 3B is a cross-sectional illustration which shows an example of the present invention;

FIG. 4 is a cross-sectional illustration which shows an example of the present invention.

FIG. 5 is a cross-sectional illustration which shows an example of the present invention.

FIG. 6 is a layout illustration which shows an example of the prior art.

### DETAILED DESCRIPTION OF THE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

It will be understood that when an element or layer is referred to as being “connected to” or “coupled to” another element or layer, it can be directly on, connected or coupled to the other element or layer or intervening elements or layers may be present.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section.

Embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

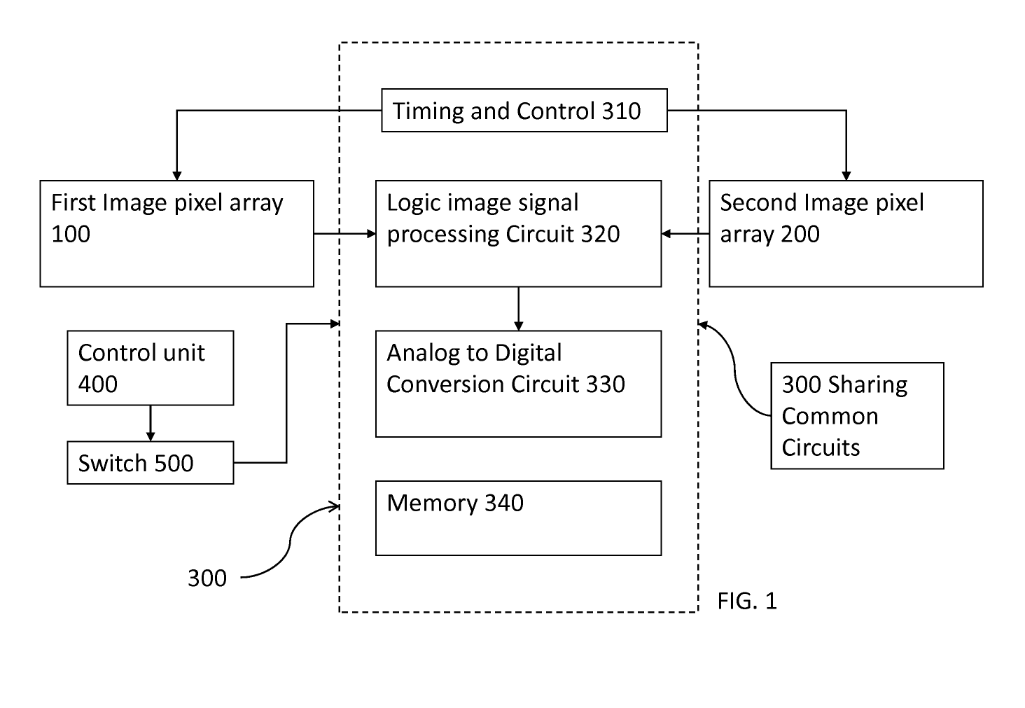

The image sensors or the image sensing module according to an embodiment of the present invention includes: a first image sensing pixel array 100, and a second image sensing pixel array 300 as shown in FIG. 1. Each of the first and second image sensing pixel array. It is well known in the art, the image sensing chip includes a system controlling unit, a vertical scanning circuit, a pixel array, a PLL (Phase Locked Loop), a horizontal scanning circuit, and a sense amplifier. The well-known amplifying device (for example a transistor) is employed for amplifying a charge corresponding to an amount of light received by a photo detector, and outputting a pixel signal; ramp signal generator (for example a reference voltage circuit) for generating a ramp signal; and comparator for comparing the pixel signal output by the amplifying device with the ramp signal output by the ramp signal generator.

Each pixel contains a photo detector and an active amplifier. The MOS is a simple switch in the pixel to read out the photodiode integrated charge. Pixels were arrayed in a two-dimensional structure, with access enable wire shared by pixels in the same row, and output wire shared by column. The vertical scanning circuit sequentially supplies a signal for controlling output of a pixel signal to pixels arranged in a vertical direction of the pixel array in predetermined timing according to control of the system controlling unit. The PLL generates a clock signal of a predetermined frequency necessary to drive each of the blocks within the CMOS sensor on the basis of an externally supplied clock signal (CK). The PLL then supplies the generated clock signal to the reference voltage circuit.

The smart phone typically includes a front camera and a rear camera, each camera has their own circuits. However, the complicated circuits occupied too much chip area and the thickness of the smart phone cannot be reduced. The embodiment include a sharing common circuits 200 for processing the first image sensing pixel array 100, and the second image sensing pixel array 300 independently or simultaneously. A switch 500 controlled by a control unit 400 is coupled with the sharing common circuits to switch the sharing circuits to process the signal for the first image sensing pixel array 100, and the second image sensing pixel array 300. Thus, the present invention may reduce the cost and thickness. The common control circuits could be timing and control 310, logic image signal processing circuit 320, analog to digital conversion circuit 330 and/or memory 340.

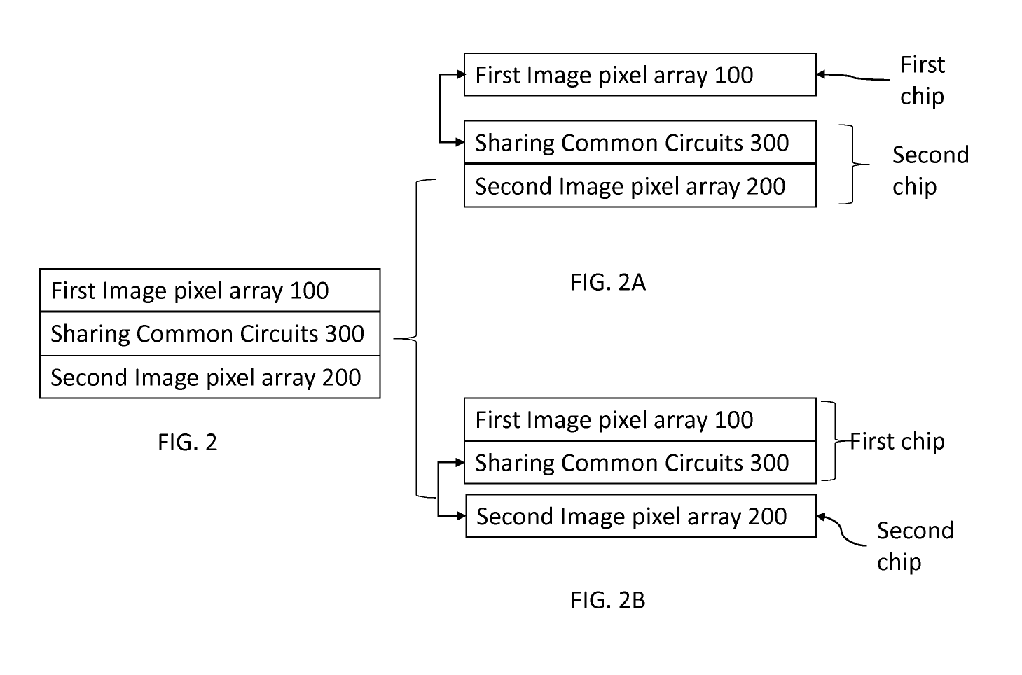

In one embodiment, the sharing common circuits 300 is formed at a first side, the first image sensing pixel array 100 is formed adjacent with the sharing common circuits 300. The second image sensing pixel array 300 is formed at the second side. The second image sensing pixel array 300 is coupled with the sharing common circuits 300 by electrical connection as shown in FIG. 2. In a preferred embodiment, the substrate may be removed or polished to 3-5 micron meter. Please refer to FIG. 2A, for the first camera of a portable device, the pixel array 100 is BSI pixel formed in the first chip (back-side of a silicon substrate) which does not contains the control circuits. For the second camera, the second chip contains the second pixel array (formed in front-side of a silicon substrate) 200 and the common control circuits (formed in front-side of a silicon substrate) 300, wherein the common control circuits are shared by the first pixel array 100. Generally, the semiconductor process for making control circuits is not compatible with pixel array. Therefore, in addition to reduction of form factor, because of process simplicity, the first pixel array 100 provides better image quality and is used for rear camera. Alternatively, the first camera may be employed for the rear or the front camera. The second camera may be for the front or rear camera. Furthermore, the first pixel array 100 and the common circuits 300 may be formed in the same single chip, and the second pixel array 200 is not, as shown in FIG. 2B. In another example, the first pixel array 100, the second pixel array 200 and the common circuits 300 are formed within three individually chips, respectively.

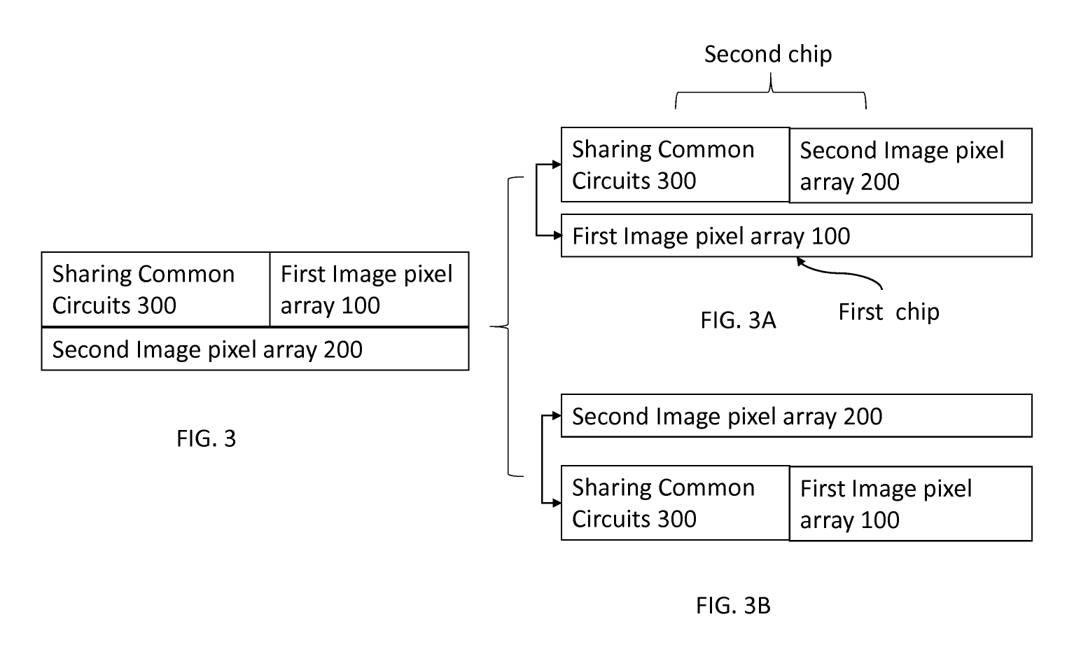

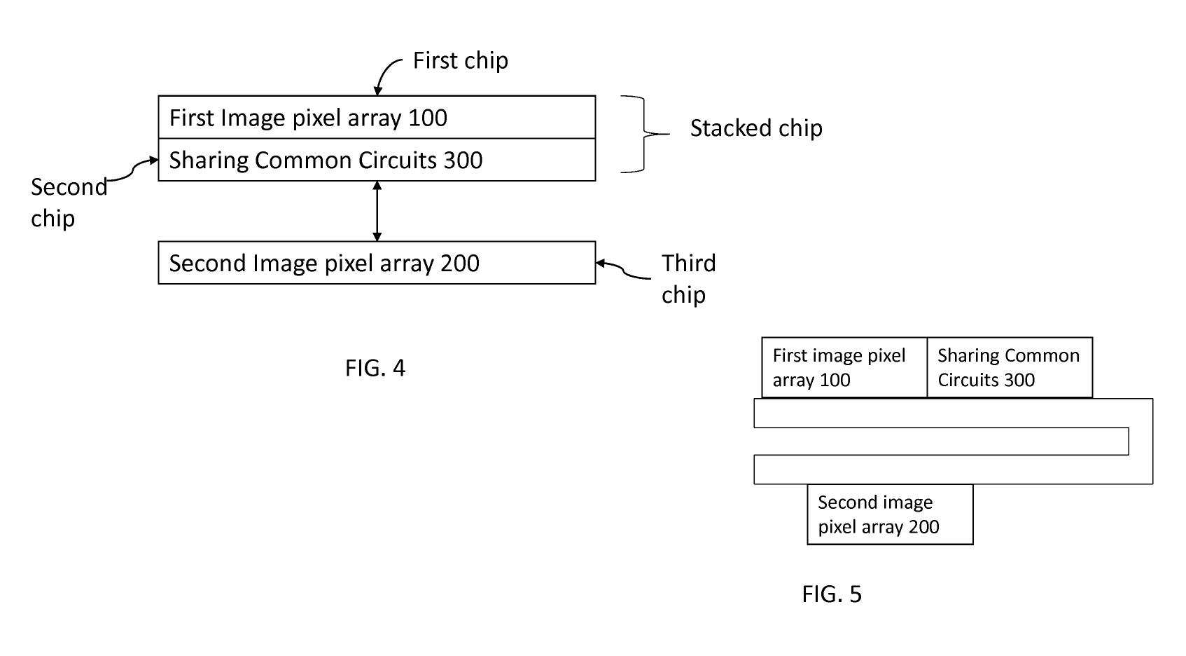

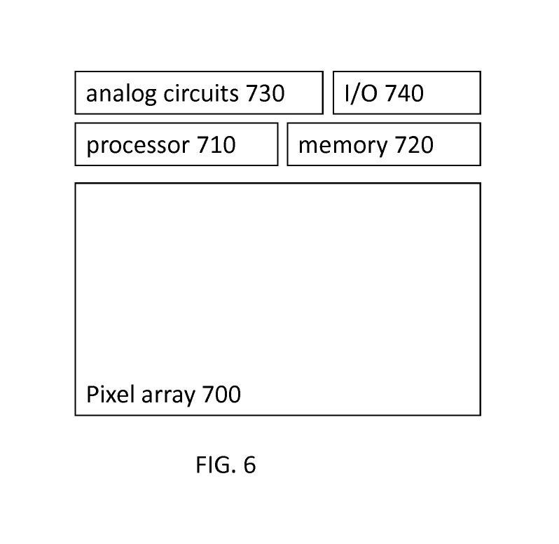

Please refer to FIG. 3, in another example, the sharing common circuits 300 is formed at the first side, the first image sensing pixel array 100 is formed adjacent with the sharing circuits 300 and at the first side. The second image sensing pixel array 300 is formed at the second side. The second image sensing pixel array 300 is coupled with the sharing common circuits 300 by TSV. In a preferred embodiment, the substrate may be removed or polished to 3-5 micron meter, please refer to FIG. 3A. Alternatively, for rear camera of a portable device, the second pixel array 200 is BSI pixel formed in the second chip (back-side of a silicon substrate) that contains the control circuits 300 (formed in front-side of the second chip). For front camera, the first chip contains the first pixel array (formed in front-side or back-side of a silicon substrate) 100 and the first chip does not contain the common control circuits, the common control circuits 300 formed in the second chip are shared by the first pixel array. Similarly, the first pixel array 100 is formed with the control circuits 300, and the second pixel array 200 does not, as shown in FIG. 3B. The first image sensing pixel array 100 is formed at the first side, the second image sensing pixel array 200 is formed at the second side. The first image sensing pixel array 300 is coupled with the sharing common circuits. The sharing common circuits 300 is formed at the second side, the second image sensing pixel array 200 is formed adjacent with the sharing common circuits 300.

In another embodiment, for rear camera of a portable device, a stacked-chip includes the first pixel array 100 formed in the first chip and common control circuits 300 formed in the second chip. For front camera, a third chip contains the pixel array 200 while not containing the common control circuits, wherein the common control circuits are shared by the third pixel array. The stacking of the first chip and the second chip further reduces form factor of the portable device. The sharing common circuits 300 is electrically connected with the first image sensing pixel array 100 and the second image sensing pixel array 200.

Turning to FIG. 5, if the substrate 1000 is flexible, the sharing common circuits 300, the first image sensing pixel array 100 and the second image sensing pixel array 200 are all formed at the same side. The substrate is bent to allow the sharing common circuits 300 and the first image sensing pixel array 100 opposite to the second image sensing pixel array 200.

Example embodiments have been disclosed herein, specific terms are used and to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. Image sensing module comprising:
a circuits;
a first image pixel array coupled with said sharing circuits;
a second image pixel array coupled with said circuits; and
a switch coupled with said circuits to switch the circuit to process signal for said first image pixel array or said second pixel array.

2. The image sensing module of claim 1, wherein said circuits includes image signal processing circuit.

3. The image sensing module of claim 1, wherein said circuits includes analog to digital conversion circuits.

4. The image sensing module of claim 1, wherein said circuits includes memory.

5. The image sensing module of claim 1, wherein said circuits includes timing and control circuits.

6. The image sensing module of claim 1, wherein said circuits and said first image pixel array are formed within a first chip, said second image pixel array is formed within a second chip.

7. The image sensing module of claim 6, wherein said circuits includes image signal processing circuit, analog to digital conversion circuits or memory.

8. The image sensing module of claim 6, wherein said circuits is adjacent with said first image pixel array.

9. The image sensing module of claim 6, wherein said first image pixel array is over said circuits.

10. The image sensing module of claim 1, wherein said first image pixel array is formed within a first chip, said second image pixel array being formed within a second chip, said sharing circuits being formed within a third chip.

11. The image sensing module of claim 10, wherein said circuits includes image signal processing circuit, analog to digital conversion circuits or memory.

12. The image sensing module of claim 10, wherein said first chip is over said second chip.

13. The image sensing module of claim 10, wherein said second chip is over said first chip.

14. The image sensing module of claim 1, wherein said first image pixel array is formed within a first chip, said circuits and said second image pixel array are formed within a second chip.

15. The image sensing module of claim 14, wherein said circuits includes image signal processing circuit, analog to digital conversion circuits or memory.

16. The image sensing module of claim 14, wherein said circuits is adjacent with said second image pixel array.

17. The image sensing module of claim 14, wherein said second image pixel array is over said circuits.

18. An image sensing module comprising:
a circuits formed on a substrate;
a first image pixel array coupled with said circuits;
a second image pixel array coupled with said circuits; and
a switch coupled with said circuits to switch the circuit to process signal for said first image pixel array or said second image pixel array, wherein said substrate is flexible, said circuits, said first image pixel array and said second image pixel array being formed at the same side; said substrate being bent to allow said circuits and said first image pixel array opposite to said second image pixel array.

19. The image sensing module of claim 18, wherein said circuits includes image signal processing circuit, analog to digital conversion circuits or memory.

20. The image sensing module of claim 18, wherein said first image pixel array is formed adjacent or over said circuits.
